(19) United States
(12) Patent Application Publication
(10) Pub. No.: US 2014/0130752 A1
(43) Pub. Date: May 15, 2014

(54) ANIMAL RESTRAINING DEVICE

(71) Applicant: Aaron Ring, Indianapolis, IN (US)

(72) Inventor: Aaron Ring, Indianapolis, IN (US)

(21) Appl. No.: 13/673,021

(22) Filed: Nov. 9, 2012

(51) Int. Cl. A01K 27/00

(52) U.S. Cl. CPC A01K 27/003; A01K 27/002
USPC 119/793

(57) ABSTRACT

A device to restrain an animal. The device comprises an elongated strap having a distal end and a proximal end, an adjustable clasp positioned at the distal end of the elongated strap, the adjustable clasp configured to engage a portion of the strap to form a first loop at or near the distal end of the strap, an engagement member positioned along the strap within the first loop, the engagement member configured to prevent the adjustable clasp from moving past the engagement member along the strap, and a securing item positioned at or near the proximal end of the strap, the securing item used to engage the strap in at least two locations to form a second loop.

### CROSS REFERENCE TO RELATED APPLICATIONS

The present application is related to, and claims the priority benefit of, U.S. Provisional Patent Application Ser. No. 61/558,495 filed Nov. 11, 2011, the contents of which are hereby incorporated in their entirety into the present disclosure.

### BACKGROUND

Several attempts have been made to develop an integrated collar and leash device, but such earlier attempts comprised two-part systems having only mixed successes. One disadvantage of the prior art systems is that they do not properly adjust to the size of the animal's neck and may choke the animal when used, which can result in discomfort and/or injury to the animal. Accordingly, an improved collar and leash system, namely a unitary device that is configured to properly restrain an animal, would be appreciated in the marketplace

### SUMMARY

In an exemplary embodiment of an animal restraining device of the present disclosure, the device comprises a harness for securing and guiding a pet, the harness comprising an elongated strap having a distal end and a proximal end, an adjustable clasp positioned along the elongated strap, the adjustable clasp configured to engage a portion of the strap at or near the distal end of the strap to form a first loop at or near the distal end of the strap, the first loop configured to secure a pet, an engagement member positioned along the strap within the first loop, the engagement member configured to prevent the adjustable clasp from moving past the engagement member along the strap, and a securing item positioned at or near the proximal end of the strap, the securing item used to engage the strap in at least two locations to form a second loop at or near the proximal end of the strap.

In at least one embodiment of a harness for securing and guiding a pet, the second loop is configured to allow a user to engage the second loop to guide the pet. In another embodiment, the harness comprises a ring positioned within the second loop, the ring configured to engage a pet leash. In yet another embodiment, the elongated strap is comprised of nylon or plastic. In other embodiments, the securing item is glue, thread, a clasp or a hook and loop fastener.

In another embodiment of an animal restraining device of the present disclosure, the device comprises a harness for securing and guiding a pet, the harness comprising an elongated strap having a distal end and a proximal end, an adjustable clasp positioned along the elongated strap, the adjustable clasp having a protruding end, a receiving member positioned at the distal end of the strap, the receiving member configured to receive the protruding end of the adjustable clasp to form a first loop at or near the distal end of the strap, the first loop configured to secure a pet, and a securing item positioned at or near the proximal end of the strap, the securing item used to engage the strap in at least two locations to form a second loop at or near the proximal end of the strap.

In at least one embodiment of a harness for securing and guiding a pet, the second loop is configured to allow a user to engage the second loop to guide the pet. In another embodiment, the adjustable clasp has an actuation member to allow a user to release the protruding end of the adjustable clasp from the receiving member. In yet another embodiment, the harness comprises a ring positioned within the second loop, the ring configured to engage a pet leash. In a further embodiment, the elongated strap is comprised of nylon or plastic. In other embodiments, the securing item is glue, thread, a clasp or a hook and loop fastener.

### BRIEF DESCRIPTION OF THE DRAWINGS

The embodiments described herein and other features, advantages and disclosures contained herein, and the manner of attaining them, will become apparent and the present disclosure will be better understood by reference to the following description of various exemplary embodiments of the present disclosure taken in conjunction with the accompanying drawing, wherein:

FIG. 1 shows a side view of an exemplary animal restraining device, according to an embodiment of the present disclosure;

FIG. 2 shows a perspective view of an exemplary animal restraining device, according to an embodiment of the present disclosure;

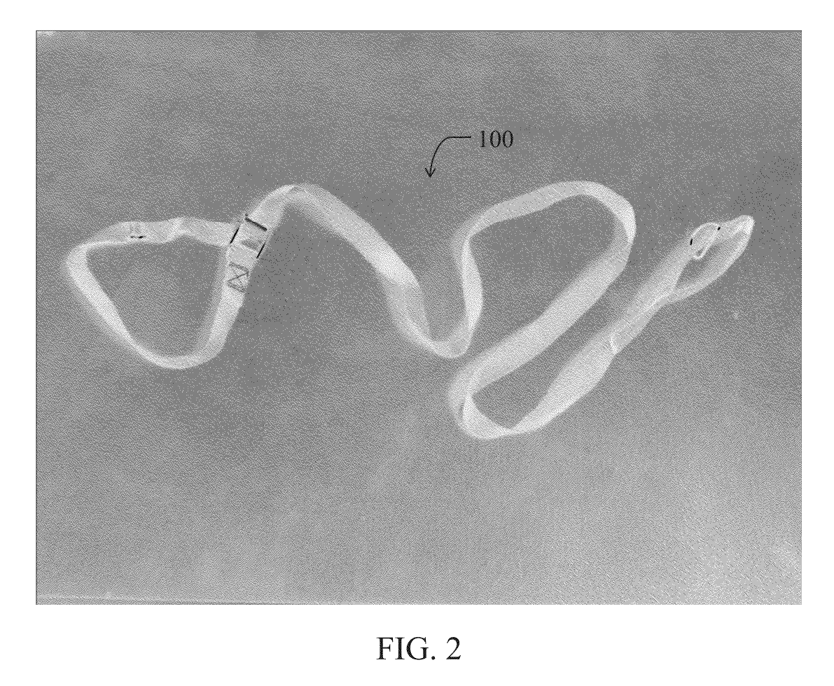

FIG. 3 shows a adjustable clasp of an exemplary animal restraining device, according to an embodiment of the present disclosure;

FIG. 4 shows a first loop of an exemplary animal restraining device, according to an embodiment of the present disclosure; and

FIG. 5 shows a adjustable clasp with protruding end of an exemplary animal restraining device, according to an embodiment of the present disclosure.

An overview of the features, functions and/or configuration of the components depicted in the figure will now be presented. It should be appreciated that not all of the features of the components of the figure are necessarily described. Some of these non-discussed features, as well as discussed features are inherent from the figure. Other non-discussed features may be inherent in component geometry and/or configuration.

### DETAILED DESCRIPTION

For the purposes of promoting an understanding of the principles of the present disclosure, reference will now be made to the embodiments illustrated in the drawing, and specific language will be used to describe the same. It will nevertheless be understood that no limitation of the scope of this disclosure is thereby intended.

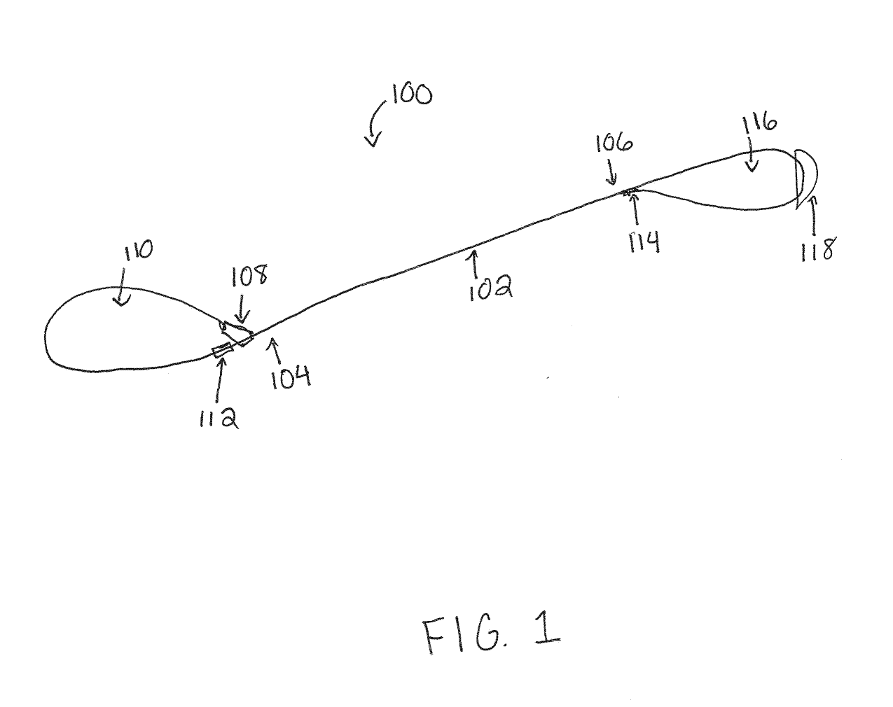

An exemplary embodiment of an animal restraining device 100 of the present disclosure is shown in FIG. 1. In the embodiment shown in FIG. 1, animal restraining device 100 includes an elongated strap 102 having a distal end 104 and a proximal end 106. The elongated strap 102 may be comprised of different materials, including, but not limited to, various plastics, nylon, rope, etc., so that various components of an exemplary animal restraining device 100 of the present disclosure would operate as intended.

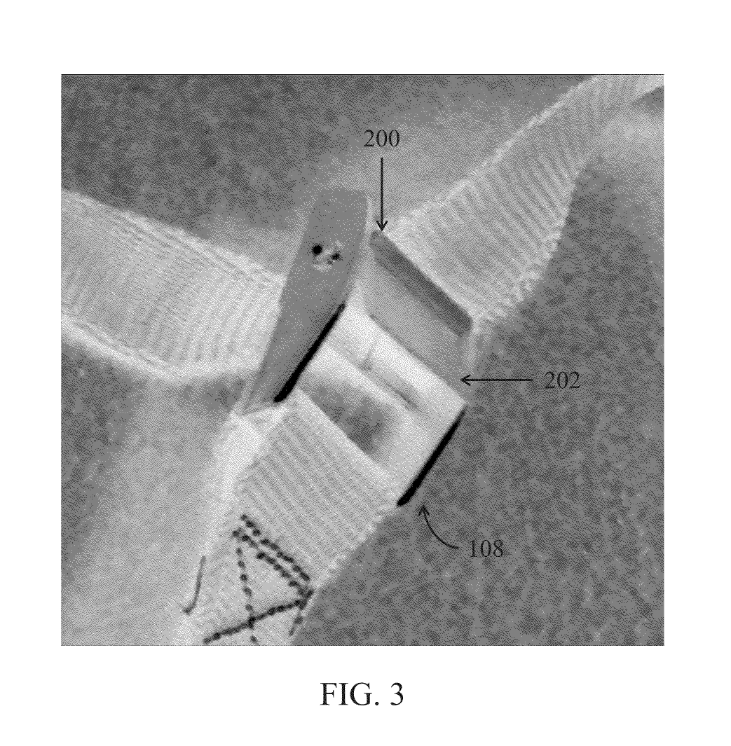

An adjustable clasp 108, in at least one embodiment, is positioned at the distal end of the elongated strap 102. Strap 102 may be looped through an aperture of adjustable clasp 108 and secured to itself with various materials, including, but not limited to, thread, glue, a hook and loop fastener, and/or one or more mechanical components, so that adjustable clasp 108 is secured to elongated strap 102. Adjustable clasp 108 is configured to engage strap 102 to form a first loop 110 at or near the distal end 104. Adjustable clasp 108 may comprise a row of teeth or other mechanism to grip elongated strap 102 to form first loop 110. In at least one embodiment, such as the embodiment shown in FIG. 3, adjustable clasp 108 may comprise an engagement portion 200 and a lever 202, wherein when a user engages lever 202, engagement portion 200 releases from elongated strap 102 to permit movement of a portion of elongated strap 102 relative to adjustable clasp 108.

First loop 110, as referenced above, is configured to secure a pet by engaging the neck of the pet. An engagement member 112, positioned along the strap 102 within first loop 110, is configured to prevent adjustable clasp 108 from moving distally past engagement member 112, so that the restraining device 100 does not choke the pet when the pet is restrained using restraining device 100. The minimum size of the first loop 110 may be adjusted by moving the adjustable clasp 108 and engagement member 112 distally or proximally along the elongated strap 102.

In at least one embodiment, a securing item 114 is positioned at or near the proximal end 106 of the strap. The securing item 114 is configured to engage the strap 102 in at least two locations to form a second loop 116 at or near proximal end 106. The securing item 114 may consist of various materials, including, but not limited to, thread, glue, a hook and loop fastener, and/or one or more mechanical components (such as a clasp), for example. The second loop 116 is configured to allow a user to engage the loop to guide a pet, either directly by engaging second loop 116, or indirectly by coupling a second item thereto (such as a retractable leash, a handle, etc.). A ring 118, in at least one embodiment, may be positioned within the second loop 116 to engage a pet leash.

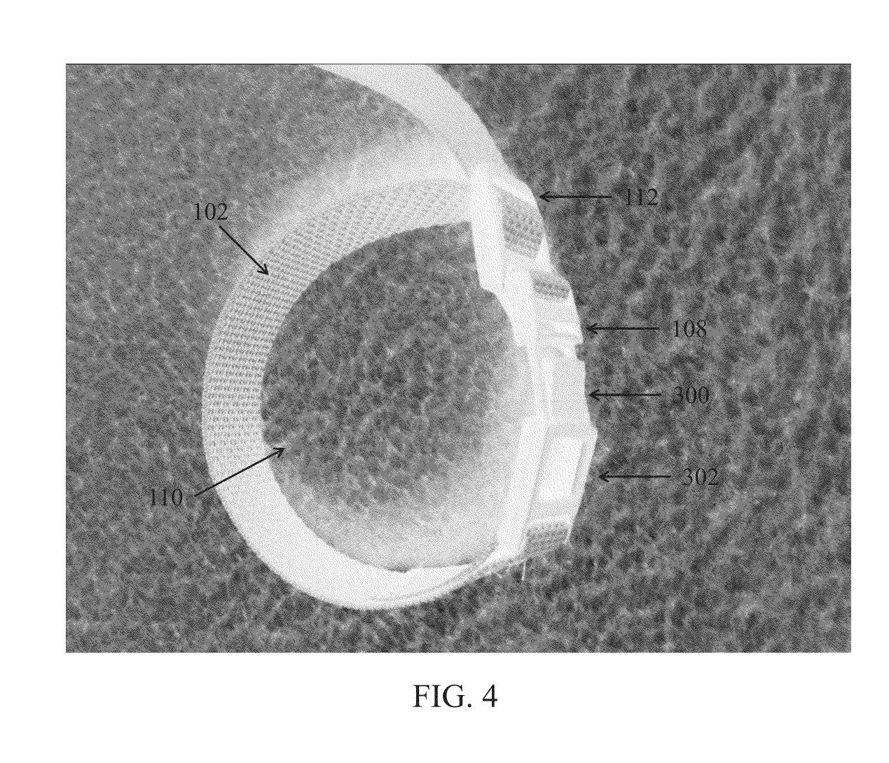

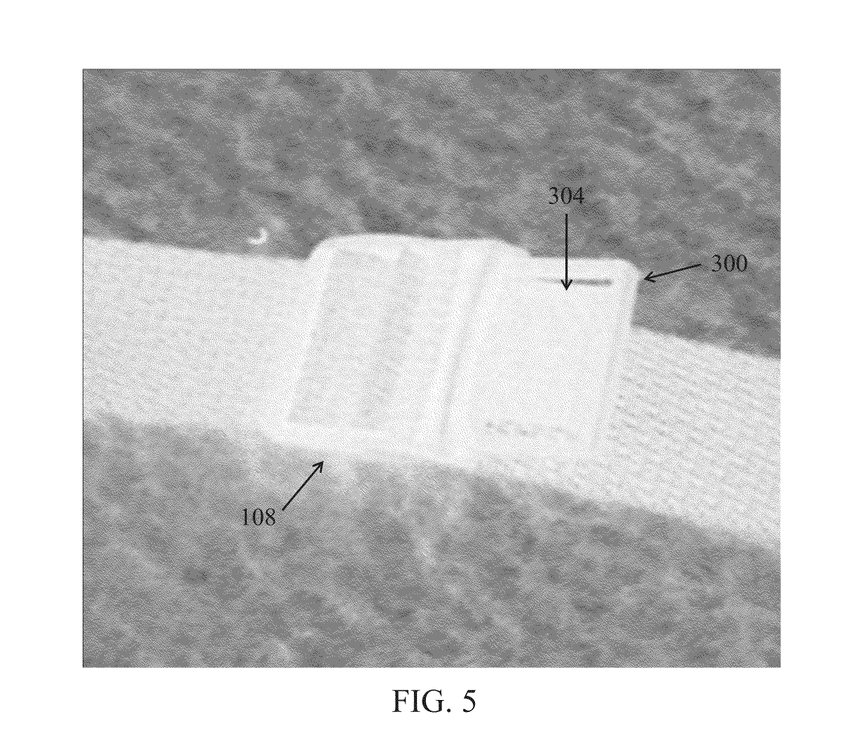

In another embodiment, such as the embodiment shown in FIG. 4, the distal end 104 of elongated strap 102 is threaded through apertures of adjustable clasp 108, so that adjustable clasp 108 is secured along strap 102 and is movable in both the proximal and distal directions along the strap. The distal end 104 of strap 102 may be looped through an aperture of receiving member 302 and secured to itself with various materials, including, but not limited to, thread, glue, a hook and loop fastener, and/or one or more mechanical components, so that the receiving member 302 is secured to the distal end 104 of the strap. Adjustable clasp 108 may further comprise a protruding end 300. The protruding end 300 is configured to engage the receiving member 302 to form first loop 110. An engagement member 112, positioned along the strap is configured to prevent adjustable clasp 108 from moving distally past engagement member 112, so that the restraining device 100 does not choke the pet when the pet is restrained using restraining device 100. The minimum size of the first loop 110 may be adjusted by moving the adjustable clasp 108 and engagement member 112 distally or proximally along the elongated strap 102. As shown in FIG. 5, adjustable clasp 108 may further comprise an actuation member 304 to allow a user to release the protruding end 300 from the receiving member 302.

While various embodiments of an animal restraining device have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A harness for securing and guiding a pet, the harness comprising:
an elongated strap having a distal end and a proximal end;
an adjustable clasp positioned at the distal end of the elongated strap, the adjustable clasp configured to engage a portion of the strap at or near the distal end of the strap to form a first loop at or near the distal end of the strap, the first loop configured to secure a pet;
an engagement member positioned along the strap within the first loop, the engagement member configured to prevent the adjustable clasp from moving past the engagement member along the strap; and
a securing item positioned at or near the proximal end of the strap, the securing item used to engage the strap in at least two locations to form a second loop at or near the proximal end of the strap.

2. The harness of claim 1, wherein the second loop is configured to allow a user to engage the second loop to guide the pet.

3. The harness of claim 1, further comprising:
a ring positioned within the second loop, the ring configured to engage a pet leash.

4. The harness of claim 1, wherein the elongated strap is comprised of nylon.

5. The harness of claim 1, wherein the elongated strap is comprised of plastic.

6. The harness of claim 1, wherein the securing item is glue.

7. The harness of claim 1, wherein the securing item is thread.

8. The harness of claim 1, wherein the securing item is a clasp.

9. The harness of claim 1, wherein the securing item is a hook and loop fastener.

10. A harness for securing and guiding a pet, the harness comprising:
an elongated strap having a distal end and a proximal end;
an adjustable clasp positioned along the distal end of the elongated strap, the adjustable clasp having a protruding end;
a receiving member positioned at the distal end of the strap, the receiving member configured to receive the protruding end of the adjustable clasp to form a first loop at or near the distal end of the strap, the first loop configured to secure a pet;
an engagement member positioned along the strap within the first loop, the engagement member configured to prevent the adjustable clasp from moving past the engagement member along the strap; and
a securing item positioned at or near the proximal end of the strap, the securing item used to engage the strap in at least two locations to form a second loop at or near the proximal end of the strap.

11. The harness of claim 10, wherein the second loop is configured to allow a user to engage the second loop to guide the pet.

12. The harness of claim 10, wherein the adjustable clasp has an actuation member to allow a user to release the protruding end of the adjustable clasp from the receiving member.

13. The harness of claim 10, further comprising:
a ring positioned within the second loop, the ring configured to engage a pet leash.

14. The harness of claim 10, wherein the elongated strap is comprised of nylon.

15. The harness of claim 10, wherein the elongated strap is comprised of plastic.

16. The harness of claim 10, wherein the securing item is glue.

17. The harness of claim 10, wherein the securing item is thread.

18. The harness of claim 10, wherein the securing item is a clasp.

19. The harness of claim 10, wherein the securing item is a hook and loop fastener.
